(19) United States
(12) Patent Application Publication
(10) Pub. No.: US 2024/0331671 A1
(43) Pub. Date: Oct. 3, 2024

(54) SWAPPABLE AND CONFIGURABLE ELECTRONIC PICKUP FOR A MUSICAL INSTRUMENT

(71) Applicant: Devon Bass, Boerne, TX (US)

(72) Inventor: Devon Smullen, Boerne, TX (US)

(21) Appl. No.: 18/619,749

(22) Filed: Mar. 28, 2024

Related U.S. Application Data
(60) Provisional application No. 63/455,784, filed on Mar. 30, 2023.

(51) Int. Cl. G10H 3/18

(52) U.S. Cl. CPC G10H 3/181; G10H 3/186

(57) ABSTRACT

A stringed instrument having a swappable and configurable electronic pickup module. The pickups in the module may detect vibrations in each string. In embodiments, the swappable pickups may be stored in a cavity that is accessible at the top face of the body of the stringed instrument under the strings. One may remove a first swappable electronic pickup module and connect a second swappable electronic pickup module. The electronic pickup module may be electronically coupled to an audio output circuit of the musical instrument such that the electric signal from the pickups is altered according to the pickup profile and any intervening pre-amplifier.

### PRIORITY CLAIM

This application claims the benefit of U.S. Provisional Application No. 63/455,784, entitled “SWAPPABLE AND CONFIGURABLE ELECTRONIC PICKUP FOR A MUSICAL INSTRUMENT” filed Mar. 30, 2023, which is incorporated by reference in its entirety herein for all purposes.

### BACKGROUND

Listening to and performing music is enjoyed by billions of people across the world and playing instruments has been a professional and recreational pursuit for many people who enjoy music. One particular subset of musical instruments that are prevalent in the music industry today include any number of stringed instruments. Stringed instruments are musical instruments that produce sound from vibrating strings when the performer plays or sounds the strings in some manner. Musicians play some string instruments by plucking the strings with their fingers or a pick while others may be played by hitting the strings with a striker or hammer or by rubbing the strings with a bow. Typical stringed instruments include guitars and violins.

In most stringed instruments, the vibrations are transmitted to the body of the instrument, which often incorporates some sort of hollow or enclosed area. The body of the instrument also vibrates, along with the air inside it. The vibration of the body of the instrument and the enclosed hollow or chamber makes the vibration of the string more audible to the performer and audience. The body of most string instruments is hollow, however, more modern stringed instruments, such as the electric guitar, utilize electric pickups that generate electronic amplification that allows for a solid wood body.

With all electric stringed instruments, electronic pickups, which may be initially described as small transducers disposed next to each string at a specific location on the body of the stringed instrument, are used to detect the vibrations of a plucked string and amplify the detected vibration into an electrical signal it in a desired way. As the pickups that are used are an electronic circuit, the nature of the detected and amplified signal may be greatly affected by the electronic components used in the electronic pickup circuit. However, as stringed instruments are manufactured, typically one or two sets of pickups are chosen and used for the instrument and cannot be easily changed to introduce new and different pickup profiles to the instrument.

### BRIEF DESCRIPTION OF THE DRAWINGS

Embodiments of the subject matter disclosed herein in accordance with the present disclosure will be described with reference to the drawings, in which:

FIG. 1 is a diagram of a conventional bass guitar having a conventional string pickup;

FIG. 2 is a view of a stringed instrument body having a cavity to seat a first electronic pickup module that can be inserted, swapped, or otherwise replaced to alter the style of electronic pickup circuit used with the stringed instrument according to an embodiment of the subject matter disclosed herein;

FIG. 3 is an exploded view of an electronic pickup module interface according to an embodiment of the subject matter disclosed herein;

FIG. 4 is an exploded view of an electronic pickup module according to an embodiment of the subject matter disclosed herein;

FIG. 5 is an isometric view of the electronic pickup module of FIG. 4 according to an embodiment of the subject matter disclosed herein;

FIG. 6 is a view of a stringed instrument body having a cavity having an electronic pickup module interface of FIG. 3 with a seated electronic pickup module of FIG. 4-5 that can be inserted, swapped, or otherwise replaced to alter the style of electronic pickup circuit used with the stringed instrument according to an embodiment of the subject matter disclosed herein; and

FIG. 7 is a system diagram of electronic components of an electric stringed instrument that may utilize the electronic pickup modular systems of FIGS. 2-6 according to an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. These systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

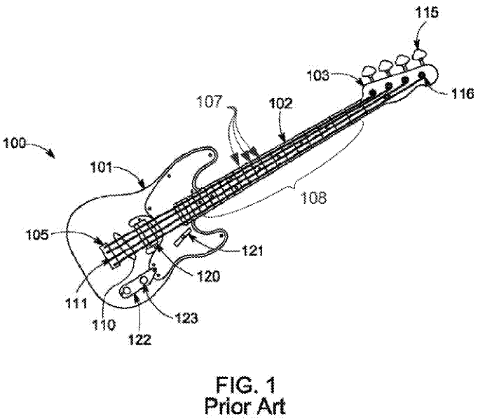

By way of an overview, the systems and methods discussed herein may be directed to a stringed instrument having at least one set of electronic or magnetic pickups associated, respectively, with each string in the stringed instrument. Collectively, the pickups detect vibration in each string as the string is plucked and then transduces the vibration signal into an electrical signal. The electrical signal may be processed in differing manners including attenuation of amplitude, filtering across a frequency spectrum or otherwise altered according to one or more transfer functions embodied in a swappable and configurable pre-amplifier. As discussed in detail herein, the electronic pickups may be part of a module that can be inserted and removed in a swappable modular manner. In embodiments, this swappable pickup module may be secured in an open-ended cavity that is accessible at the front of the body of the stringed instrument disposed under strings. In further embodiments, the swappable pickup module may be secured directly to the body of the instrument via fasteners or magnetic attachments. One may remove a first swappable pickup module and connect a second swappable pickup module. The pickup module may further be electronically coupled to an audio circuit of the musical instrument such that the electric signal from the pickups is sent to a pre-amplifier profile module. Further yet, the pickup module may interface with an electronic switch for changing one or more electronic profiles of the electronic pickup module or may be used switch the entire pickup module on or off. Any number of different pickup module profiles are contemplated as discussed below. These aspects and other novel features are discussed below with respect to FIGS. 1-7.

FIG. 1 is a diagram of a conventional bass guitar 100 having conventional means for implementing a pickup 120 next to strings 110 that are supported by a string bridge 105. Generally speaking, a pickup 120 is a transducer that captures, or senses mechanical vibrations produced by musical instruments, particularly stringed instruments such as an electric guitar or electric bass guitar. The sensed vibrations are then converted to electrical signals that may be amplified using an instrument amplifier to produce musical sounds through a loudspeaker. The signal from a pickup 120 can also be recorded directly into direct out systems in recording environments or other live sound environments. Most electric guitars and electric basses use magnetic pickups. Acoustic guitars, upright basses and fiddles often use a piezoelectric pickup.

As shown in FIG. 1, a conventional stringed instrument 100 is shown to illustrate the drawbacks of a typical stringed instruments wherein the single integrated pickup 120 has but one single profile for how vibrations are translated into electrical signals. While FIG. 1 shows a bass guitar 100, a skilled artisan understands that these concepts illustrated here apply to any conventional stringed instrument. Further, the skilled artisan will also appreciate the application of the novel concepts discussed herein as also applying equally to any stringed instrument. As such, the remainder of this detailed description will remain focused on the application to a bass guitar 100 for brevity.

In FIG. 1, a bass guitar 100 is shown having four strings 110 attached thereto. The strings 110 are attached at a first anchor point 111 that is situated on an anchor bridge 105 disposed on the front face of a body 101. The other end of each string 110 is coupled to a second anchor point located at a head stock 103 at and end opposite the body 105 such that each string spans a neck 102. The strings 110 span the neck 102 over a fretboard that includes frets that a player may use to play different notes. The strings 110 are typically coupled to a tuning device 115 that is configured to rotate a respective nut when one actuates one of multiple tuning keys 116. That is, a first string 110 may be tightened or loosened between the string bridge 105 and a first tuning device 116 by turning a first tuning key 115. Likewise, a second string 110 may be tightened or loosened between the string bridge 105 and a second tuning device 116 and by turning a second tuning key 115, and so on.

Each string 110 spans the neck 102 which includes a fretboard having frets 107. As a player places one or more fingers on each string 110, the string may make contact with a fret 107 and then, when struck or plucked, vibrate at a frequency commensurate with the distance between the fret 107 and a string anchor point 111 that is part of the conventional string bridge 105. As a player's finger moves up and down the fretboard (e.g., neck 102), different frets 107 may be engaged for each string 110, thereby producing a different vibrations frequency (e.g., a different note). In stringed instruments, the length of the fretboard defines the instrument's scale length. A skilled artisan also understands that some stringed instruments are players without frets on a fretboard. Rather, the neck includes a fingerboard (e.g., a fretboard without frets) where a skilled artisan learns where to place fingers for producing desired notes without the precision of the fret.

Further, a typical bass guitar 100 will include a permanently incorporated electronic pickup 120 that is configured to detect the vibration of each string and amplify the frequency of the sound. That is, a pickup 120 is, essentially a respective set of microphones disposed directly under each string 110. The audio signal detected may be further modified by circuitry controlled by a volume knob 122 and a tone control knob 123. Further yet, the bass guitar body 101 may include a pickguard 121. As has been alluded to, having a permanently fixed electronic pickup limits the instrument to a single pickup profile chosen by the original manufacturer of the instrument. Having an ability to change the electronic profile of the electronic pickup 120 would be beneficial for making the instrument more versatile and usable across many playing styles and music genres.

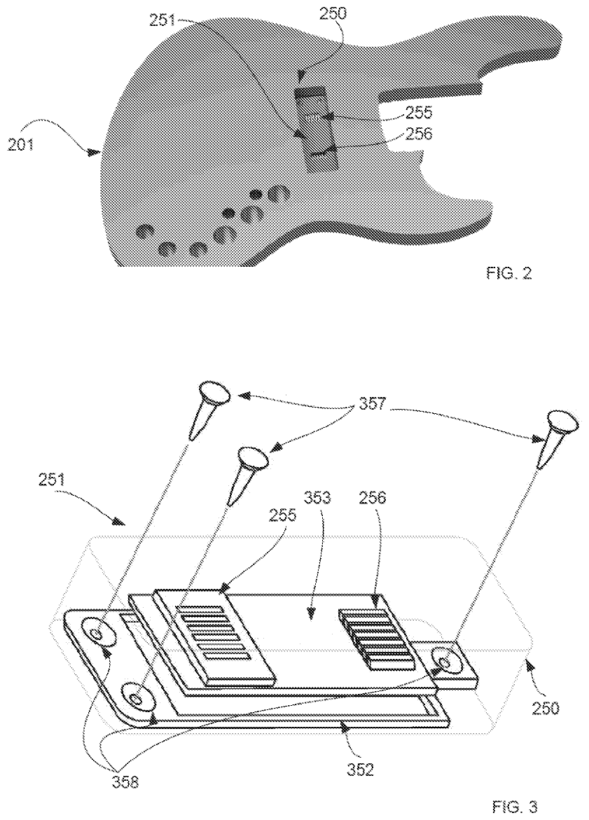

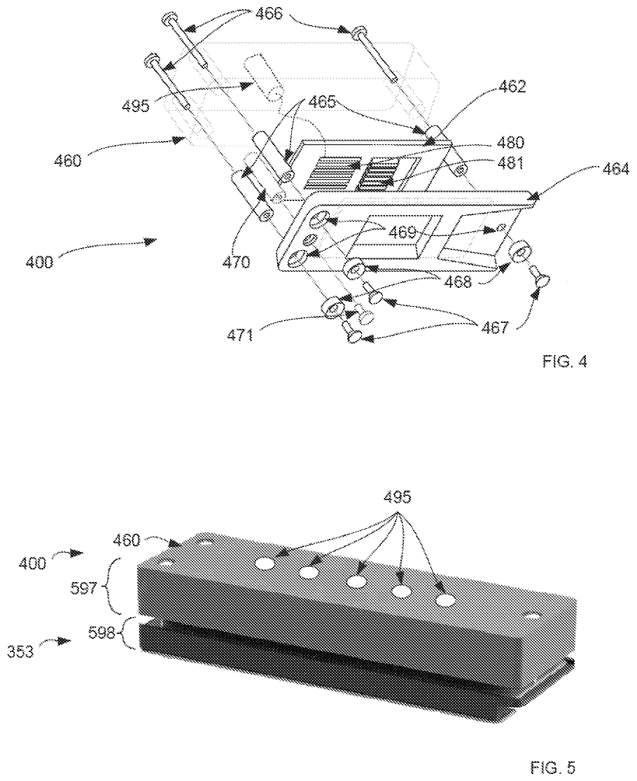

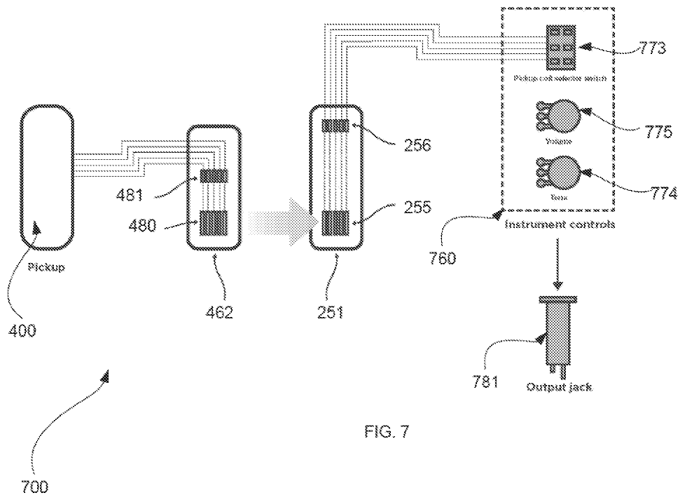

FIG. 2 is a view of a stringed instrument body 201 having a cavity 250 to seat a first electronic pickup module (not shown in FIG. 2) that can be inserted, swapped, or otherwise replaced to alter the style of the electronic pickup circuit used with the stringed instrument according to an embodiment of the subject matter disclosed herein. In this embodiment, the cavity 250 may include four walls to form a rectangular hole for receiving an electronic pickup module (shown and discussed in FIG. 4 below). An electronic pickup module may be swappable in that additional (differently profiled) electronic pickups may be inserted into the cavity 250 after a first one is removed from the cavity 250. Each electronic pickup module cavity 250 is configured to have an electronic pickup module interface 251 mounted therein. The electronic pickup module interface 251 includes a first set 255 and second set 256 of wire connectors for engaging the specific electronic components in the electronic instrument (described below with respect to FIG. 7). That is, once the electronic pickup module in inserted and seated in the cavity 250, each microphone in the electronic pickup module may generate signals to be transmitted through the signal connecters 255 and 256 that is located adjacent to the bottom wall of the cavity 250. Thus, the specific electronic profile of each individual microphone is an electronic pickup module affects the audio output chain of the stringed instrument. An electronic pickup module is more readily swappable because of the connectors 255 and 256 disposed in the cavity 250.

Prior to discussing additional novel features disclosed herein, it is noted that a person would have to engage a technician to hardwire a new electronic pickup into an instrument in a typical conventional stringed instrument that does not have such a cavity for receiving an easily swappable electronic pickup module. This typically involves paying a guitar technician to solder in the electronic components such as pickups and grounds into said instrument. One innovation of the current swappable and configurable electronic pickup module is the use of a universal signal interface for third-party electronic pickup modules. Such a system enables a musician to quickly swap-out electronic pickup modules thereby allowing the musician quick changes to the entire audio profile of the instrument.

FIG. 3 is an exploded view of an electronic pickup module interface 251 according to an embodiment of the subject matter disclosed herein. In this embodiment, an electronic pickup module interface 251 is shown with component parts more readily seen in this exploded view. As this electronic pickup module interface 251 is intended to be mounted inside the cavity 250 of a stringed instrument body, the various parts of the electronic pickup module interface 251 may be interchangeable for ease of repair and replacement. Thus, FIG. 3 shows a faint outline of the cavity 250 from the stringed instrument body 201 of FIG. 2.

The electronic pickup module interface 251 includes a printed circuit board (PCB) 353 having electronics for signal processing for received signal from electrically coupled transducer, i.e., electronic pickups (not shown here as the pickups are in electronic pickup module—described below). The interface PCB 353 includes a first set of electronic connectors 255 in the form of a five-point direct-contact interface. The interface PCB 353 also includes a second set of electronic connectors 256 in the form of a second five-point direct-contact interface. Each connector may, in turn, be electrically coupled to a signal processing circuit (not shown) for audio signals that ultimately is delivered to an output jack on the electronic stringed instrument. In other embodiments, only one of the direct contact interfaces is disposed on the interface PCB 353. In still other embodiments, the number of direct contact points may be more than or fewer than five.

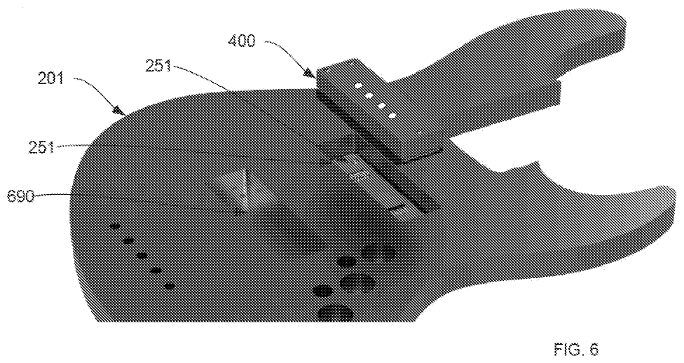

The PCB interface 353, the first five-point connector 255 and the second five-point connector 256 are mounted to an interface PCB mounting plate 352 to be secured within the cavity 250. As shown in this embodiment, the interface PCB mounting plate 352 includes three interface mounting holes 358 sized to receive three interface mounting fasteners 357. As the interface PCB mounting plate 352 is to be mounted to a bottom wall of the body cavity 250 in a wood body, the fasteners 357 may be wood screws. In other embodiments, the fasteners may be machine screws in the case of a non-wood body 201 for the stringed instrument. In some embodiments, respective connection points between the first and second electronic connectors 255 and 256 are electronically coupled to each other through PCB wire traces on the interface PCB 353. With the electronic pickup module interface 251 mounted to the bottom wall of the cavity, electronic pickup module may be magnetically secured to the cavity as discussed next with respect to FIGS. 4-5.

FIG. 4 is an exploded view of an electronic pickup module 400 according to an embodiment of the subject matter disclosed herein. In this embodiment, the electronic pickup module 400 includes a form factor of a long rectangular module body 460 sized to fit snuggly in the cavity 250 (FIG. 2) of the stringed instrument body 201. The module body 460 also houses a plurality of magnetic cores (only one is shown in FIG. 4) that produce a magnetic field, perturbations of which may be detected by a wound wire (not shown in detail) that are, in turn, electronically coupled to one or more respective spring connectors of a respective connector point with an electronic connector interface 481. Thus, induced electric signals in the wound wire are carried to the electronic connector interface 481 in response to detecting string vibrations that interrupt the magnetic field of a respective magnet 495. As was the case with the electronic pickup module interface 400, above, the first and second electronic connectors 480 and 481 are part of an electronic pickup module PCB 462 that is mounted to an electronic pickup module PCB mounting plate 464. In some embodiments, respective connection points between the first and second electronic connectors 480 and 481 are electronically coupled to each other through PCB wire traces on the electronic pickup module PCB 462.

As shown in this embodiment, the electronic pickup module PCB mounting plate 464 includes three mounting holes 469 sized to receive three mounting fasteners 467 that may be threaded into three respective threaded spacers 465. As the module PCB mounting plate 352 is to be secured to the electronic pickup module interface 251 magnetically, the fasteners 357 may also secure three magnets 468 (other embodiments may have more than three) respectively to the base of the electronic pickup module. In some embodiments, the magnets 468 may secure to the fasteners 357 or to another set of polarity-coupled magnets (not shown). The electronic pickup module body 460 may also be secured to the electronic pickup module PCB mounting plate 464 using a second set of three fasteners 466 (other embodiments may have more than three) that may be threaded into a second end of a respective threaded spacer 465. In this embodiment, the fasteners may be machine screws.

Also as shown in this embodiment, an additional optional spacer 470 is show that may be held in place by a matching optional spacer screw 471. Further, some embodiments may have spring tensioning members surrounding each spacer 465 to provide additional locking force to maintain the fasteners 467 in holding the electronic pickup module together. Further, in some embodiments, coupling wires that electronically couple the electronic pickups (that each comprise a magnet 495 having a respective wound signal wire coiled hundreds of times around the magnet in order to capture magnetic field interruptions caused by a vibrating string) that may carry signal generated to a respective connection point disposed in the bottom portion 598 of the electronic pickup module 400 where the electronic pickup module PCB mounting plate 464 is disposed (holding the connection-point interfaces 480 and 481 that cannot be seen in FIG. 5). to the contact points of the electronic connector interfaces 480 or 481 may disposed through one or more spacers 465.

FIG. 5 is an isometric view of the electronic pickup module 400 sitting on top of the electronic pickup interface module 353 of FIGS. 3-4 according to an embodiment of the subject matter disclosed herein. This view is a stand-alone electronic pickup module 400 and electronic pickup interface module 353 suitable for swapping in and out of matched instrument body cavities. This embodiment includes a top portion 597 (that corresponds to the electronic pickup module 400) having five magnets 495 (that are part of respective electronic pickups) suitable to be situated directly under each of five respective strings in a bass guitar. In other embodiments, each magnet 495 as shown may be a matched pair working in tandem to capture vibrations from adjacent strings (not shown). In still other embodiments, the number or electronic pickups (or number of matched pairs of pickups) may be four for a four-string bass guitar or six for a typical electric guitar. In still further embodiments, any number of strings for stringed instrument may be accommodated. Each set of electronic pickups may carry signals generated to a respective connection point disposed in the bottom portion 598 (that corresponds to the electronic pickup module 400) where the electronic pickup module PCB mounting plate 464 is disposed (holding the connection-point interfaces 480 and 481 that cannot be seen in FIG. 5). In turn, signal wires may be disposed inside vias located on one or more of the three shown support posts that link the top portion of the bottom portion.

As was discussed above, magnetic or mechanical couplers may be used to hold the top portion 597 to the bottom portion 598 in a manner that the respective connection point interfaces make electrical contact. That is, the electronic pickup module 400 engages the matching electronic pickup module interface 353 disposed in a cavity of guitar body. Additionally, the support members may be surrounded by wound and grounded wiring so as to reduce or even eliminate signal interference or cancellation from undesired electronic or magnetic fields. That is, the support posts are shielded.

Further, the height of the electronic pickup module 400 with respect to the electronic pickup module interface 353 may be set to a desired height and adjusted as necessary. Further, once the height has been adjusted, the position of the electronic pickup module 400 with respect to a corresponding electronic pickup module interface 353 will be maintained after swapping in different electronic pickup modules 400. Thus, the position and height of any electronic pickup module 400 need not be readjusted every time an electronic pickup module 400 is swapped-in.

FIG. 6 is a view of a stringed instrument body 201 having a cavity 250 having an electronic pickup module interface 251 of FIG. 3 with an unseated electronic pickup module 400 of FIG. 4-5 that can be inserted, swapped, or otherwise replaced to alter the style of electronic pickup circuit used with the stringed instrument according to an embodiment of the subject matter disclosed herein. As shown here, the electronic pickup module 400 has been removed from any body cavity 250 including a second possible body cavity 690. Although not shown, the stringed instrument body 201 may have additional cavities for additional swappable electronic pickups, including a third cavity and a fourth cavity. This state is ready now for the string instrument to receive the electronic pickup module 400 to be swapped into the audio output chain. This embodiment may also have a second electronic pickup module (not shown) inserted into the second cavity 690 that may have its own second electronic pickup module interface (not shown).

FIG. 7 is a hybrid block and schematic diagram of the swappable and configurable electronic pickup system in an overall electric bass guitar (or any stringed instrument such as an electric guitar) according to an embodiment of the subject matter disclosed herein. In this example embodiment, the underlying musical instrument is an electric bass guitar, but a skilled artisan understands that any electric stringed instrument may utilize the swappable electronic pickup module features detailed herein. The entire block diagram may be considered the audio output circuit such that the circuit includes an electronic pickup module 400 and interface 251 for facilitating the transmission of each pickup signal to additional altering componentry. The additional componentry shown in FIG. 7 includes instrument controls that include volume and tone.

Sometimes, this overall set of electronic componentry is called the harness 700. In this block diagram, one can see the electronic pickup module 400 that may be disposed near strings (not shown in this block diagram). As a pickup module 400 may be swapped into the stringed instrument, the five-point connectors of the electronic pickup module PCB 462 may interface with (e.g., respective electrical spring connectors contact each other) with the electronic pickup module interface PCB 251 disposed in a cavity of the body of the stringed instrument. That is, the five-point spring connectors 480 will align and galvanically contact the respective five-point connector 255 in the electronic pickup module interface PCB 251.

The additional componentry shown in FIG. 7 includes instrument controls 760 that include a pickup-selector switch 773, tone 774, and volume 775. The harness 700 may culminate in an audio output which may be a ¼″ audio jack 781 for an instrument cable. In other embodiments, the audio output chain may culminate in a Bluetooth or other wireless output means (not shown).

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A musical instrument, comprising:
an instrument body having a cavity configured to receive a swappable electronic pickup module;
an electronic pickup module interface disposed in the cavity and configured to electrically couple to an electronic pickup module that may be swapped in and out of the cavity;
an electronic pickup module configured to electrically couple to the electronic pickup module interface and configured to generate an electrical signal from vibrations from one or more adjacent strings, wherein the electrical signals generated are altered by an electronic pickup profile associated with the electronic pickup module; and
an audio output circuit coupled to the pickup module and configured to provide the altered electrical signal to an output jack.

2. The musical instrument of claim 1, wherein the electronic pickup module interface comprises at least one five-point electrical wire connector.

3. The musical instrument of claim 1, further comprising an electronic pre-amplifier module disposed in the body and coupled to the electronic pickup module, the electronic pre-amplifier configured to further alter the electrical signal and including:
a first signal processing device suited to alter the received electrical signal in frequencies at a high end of a human range of hearing;
a second signal processing device suited to alter the received electrical signal in frequencies at a low end of the human range of hearing; and
a third signal processing suited to alter the received electrical signal in frequencies between the high end and the low end of the human range of hearing.

4. The musical instrument of claim 1, wherein the electronic pickup module further comprises four individual pickup microphones, each positioned to be respectively disposed adjacent to a respective one of four strings.

5. The musical instrument of claim 1, further comprising a volume attenuation device coupled to the audio output circuit and configured to alter the amplitude of the altered electrical signal.

6. The musical instrument of claim 1, further comprising at least one second electronic pickup module disposed in a second cavity adjacent to respective strings, the second electronic pickup module positioned to detect vibrations from the adjacent respective strings and to generate a second electrical signal in response to detected vibrations.

7. The musical instrument of claim 1, further comprising a battery disposed in a battery cavity in the body and configured to provide electrical power to the electronic pickup module through the electronic pickup module interface.

8. The musical instrument of claim 1, wherein the electronic pickup module further comprises a plurality of magnetic fasteners disposed in the electronic pickup module and configured to hold the electronic pickup module in the cavity.

9. The musical instrument of claim 1, further comprising a metallic lining disposed over an interior contour of the cavity and configured to inhibit electromagnetic signals from interfering with circuitry disposed in the cavity and in the electronic pickup module.

10. The musical instrument of claim 1, wherein the electronic pickup module further comprises a height corresponding to distance from the adjacent strings when the electronic pickup module is electrically coupled to the electronic pickup module such that the distance does not change when the electronic pickup module is swapped out and swapped in again.

11. A stringed instrument system, comprising:
an instrument body having a cavity configured to receive an electronic pickup module;
a plurality of strings secured between a head and the body along a neck that is attached to the body;
an electronic pickup module interface disposed in the cavity and configured to electrically couple to an electronic pickup module that may be swapped in and out of the cavity;
an electronic pickup module configured to electrically couple to the electronic pickup module interface and configured to generate an electrical signal from vibrations from one or more adjacent strings, wherein the electrical signals generated are altered by an electronic pickup profile associated with the electronic pickup module; and
an audio output circuit coupled to the electronic pickup module and configured to provide the altered electrical signal to an output jack.

12. The stringed instrument system of claim 11, further comprising a pre-amplifier module disposed in the body and coupled to the electronic pickup module, the pre-amplifier configured to further alter a received electrical signal generated by the electronic pickup module and including:
a first signal processing device suited to alter the received electrical signal in frequencies at a high end of a human range of hearing;
a second signal processing device suited to alter the received electrical signal in frequencies at a low end of the human range of hearing; and
a third signal processing suited to alter the received electrical signal in frequencies between the high end and the low end of the human range of hearing.

13. The stringed instrument system of claim 11, further comprising at least one second electronic pickup module disposed in a second cavity adjacent to respective strings positioned to detect vibrations from the adjacent respective strings, the at least one second electronic pickup module configured to generate a second electrical signal in response to detected vibrations.

14. The stringed instrument system of claim 11, further comprising a battery disposed in a battery cavity and configured to provide electrical power to the electronic pickup module through the electronic pickup module interface.

15. The stringed instrument system of claim 11, wherein the electronic pickup module further comprises a plurality of magnetic fasteners disposed in the electronic pickup module and configured to hold the electronic pickup module in the cavity.

16. The stringed instrument system of claim 11, further comprising a metallic lining disposed over an interior contour of the cavity and configured to inhibit electromagnetic signals from interfering with circuitry disposed in the cavity.

17. The stringed instrument system of claim 11, further comprising a wireless communication module electrically coupled to the electronic pickup module and configured to receive remote signals from a remote computing device to adjust a manner in which electrical signals generated by the electronic pickup module are altered.

18. A method of configuring a musical instrument, comprising:
in a stringed musical instrument, magnetically securing a first electronic pickup module in a cavity in a body of the stringed instrument, the first electronic pickup having a plurality of pickup circuits each disposed adjacent to a respective string when the first electronic pickup is secured in the cavity;
applying a force to the first electronic pickup module to unsecure the first electronic pickup module from the cavity, the force having a magnitude to overcome a magnetic force securing the first electronic pickup module in the cavity;
removing the first electronic pickup module from the cavity; and
swapping in a second electronic pickup module and magnetically securing a second electronic pickup module in the cavity, the second electronic pickup module having a plurality of pickup circuits each disposed adjacent to a respective string when the second electronic pickup module is secured in the cavity.

19. The method of claim 18, wherein:
the first electronic pickup module is removed from the electronic pickup module interface disposed in the cavity and configured to electrically couple to the first electronic pickup module to circuitry for the stringed instrument; and
the second electronic pickup module is inserted to couple with the electronic pickup module interface and configured to electrically couple to the second electronic pickup module to circuitry for the stringed instrument.

20. The method of claim 18, further comprising:
receiving a wireless control signal from a remote computing device communicatively coupled to the second electronic pickup module; and
adjusting the second manner in which the second electronic pickup module alters the electrical signal in response to the wireless control signal.
